(19) United States
(12) Patent Application Publication
(10) Pub. No.: US 2009/0225006 A1
(43) Pub. Date: Sep. 10, 2009

(54) Plasma Display Apparatus

(76) Inventors: Makoto Onozawa, Miyazaki (JP); Yasunobu Hashimoto, Miyazaki (JP); Tomokatsu Kishi, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/720,963

(22) PCT Filed: Aug. 4, 2005
(86) PCT No.: PCT/JP05/14348

§ 371 Date: Jun. 6, 2007

(51) Int. Cl. G09G 3/20

(52) U.S. Cl. 345/60

(57) ABSTRACT

A plasma display apparatus such that the size of a drive control circuit is reduced and malfunction due to noise is prevented. The plasma display apparatus comprises an X-electrode driving circuit (3) including an X-drive control circuit (9), a Y-electrode driving circuit (4) including a Y-drive control circuit (10), an address electrode driving circuit (5) including an address drive control circuit (11), and a microprocessing unit (MPU) (8) for supplying trigger signals and DATA signals to the X-drive control circuit (9), Y-drive control circuit (10), and address drive control circuit (11). Data processing is performed on the trigger signals and DATA signals output from the microprocessing unit (8), thereby generating an X-electrode driving pulse supplied to an X-electrode, a Y-electrode driving pulse, and an address electrode driving pulse.

### TECHNICAL FIELD

The present invention relates to a plasma display apparatus. To be more precise, preferred embodiments of the present invention provide a plasma display apparatus which has reduced size of a drive control circuit and prevents a malfunction due to noise.

### BACKGROUND ART

A conventional plasma display apparatus processed an inputted video signal in a signal processing circuit 1 and supplied it to a drive control circuit 2 as shown in FIG. 1. The drive control circuit 2 formed control signals to be supplied to an X electrode drive circuit 3, a Y electrode drive circuit 4, an address electrode drive circuit 5 and a scan circuit 6 based on output signals of the signal processing circuit.

FIG. 6 is a diagram showing operating waveforms of the plasma display apparatus. A reset waveform is supplied to a Y electrode in a reset period, an address waveform is supplied to a Y electrode and an address electrode in an address period, and a sustain waveform is alternately supplied between the X electrode and the Y electrode in a sustain period.

Patent Document 1 indicates a conventional technique of generating a control signal to be supplied to a drive circuit of the plasma display apparatus.

Patent Document 2 indicates a conventional technique of simplifying a control signal of the plasma display apparatus.

Patent Document 1: National Publication of International Patent Application No. 2002-519739

Patent Document 2: Japanese Patent Laid-Open Publication No. 2004-252017

The conventional drive control circuit 2 generated various control signals to be supplied to the X electrode drive circuit 3, Y electrode drive circuit 4, address electrode drive circuit 5 and scan circuit 6, and supplied them to these circuits. As a result of this, the drive control circuit 2 required a large-scale LSI, which required extended development periods. It also required a large number of signal cables and connectors for connecting between substrates for the sake of transmitting the various control signals. Furthermore, in the case where noise was superimposed on the control signal, there was a high possibility that a switch element (such as an output element of a sustain circuit) driven by the control signal might malfunction and go out of order.

The conventional techniques did not give consideration to solutions of problems including a method of preventing the malfunction due to the noise.

An object of the present invention is to provide a plasma display apparatus which has a reduced size of the drive control circuit 2 and also has reduced numbers of pins of cables and connectors and further prevents the malfunction due to noise.

### DISCLOSURE OF THE INVENTION

To attain the object, the present invention is a plasma display apparatus including: an X drive control circuit inside an X electrode drive circuit for generating a control signal to be supplied to the X electrode drive circuit; a Y drive control circuit inside a Y electrode drive circuit for generating a control signal to be supplied to the Y electrode drive circuit; an address drive control circuit inside an address electrode drive circuit for generating a control signal to be supplied to the address electrode drive circuit; and a control device for supplying trigger signals and DATA signals to the X drive control circuit, Y drive control circuit and address drive control circuit, wherein an X electrode drive pulse, a Y electrode drive pulse and an address electrode drive pulse to be supplied to the X electrode are formed by performing data processing on the trigger signals and DATA signals outputted by the control device.

It is possible, by using the present invention, to provide a plasma display apparatus which has reduced size of a drive control circuit and also has reduced numbers of pins of signal cables and connectors and further prevents a malfunction due to noise.

### BRIEF DESCRIPTION OF THE DRAWINGS

FIG. 1 is a diagram showing a conventional example of a plasma display apparatus;

FIG. 2 is a diagram showing a first embodiment of a plasma display of the present invention;

FIG. 3 is a diagram showing a second embodiment of the plasma display of the present invention;

FIG. 4 is a diagram showing a concrete example 1 of a sustain circuit of the plasma display apparatus of the present invention;

FIG. 5 is a diagram showing a concrete example 2 of the sustain circuit of the plasma display apparatus of the present invention; and

FIG. 6 is a diagram showing operating waveforms of the plasma display.

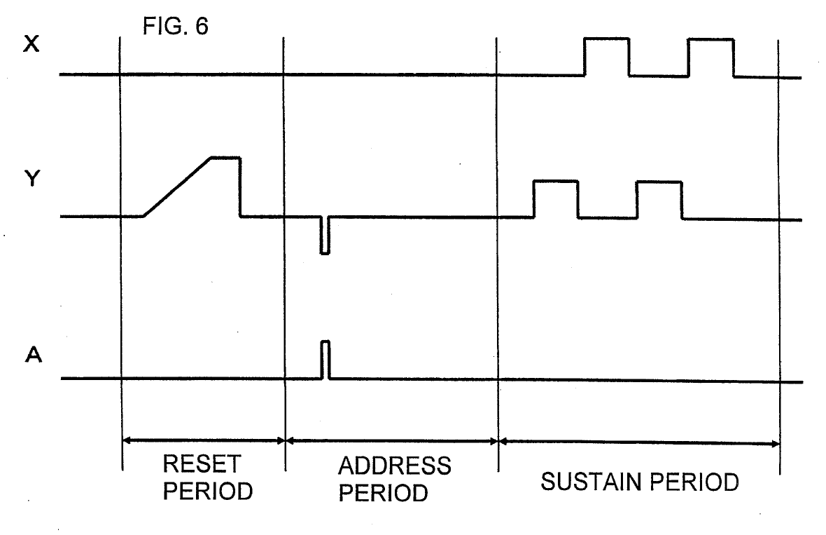

### DESCRIPTION OF SYMBOLS

1 Signal processing circuit
2 Drive control circuit
3 X electrode drive circuit
4 Y electrode drive circuit
5 Address electrode drive circuit
6 Scan circuit
7 Plasma display panel
8 Control device (MPU)
9 X drive control circuit
10 Y drive control circuit
11 Address drive control circuit
12 Scan drive control circuit
13 Pre-drive circuit
14 Data processing circuit
15 Signal generating circuit

### BEST MODE FOR CARRYING OUT THE INVENTION

Hereunder, embodiments of the present invention will be described by using the drawings.

### First Embodiment

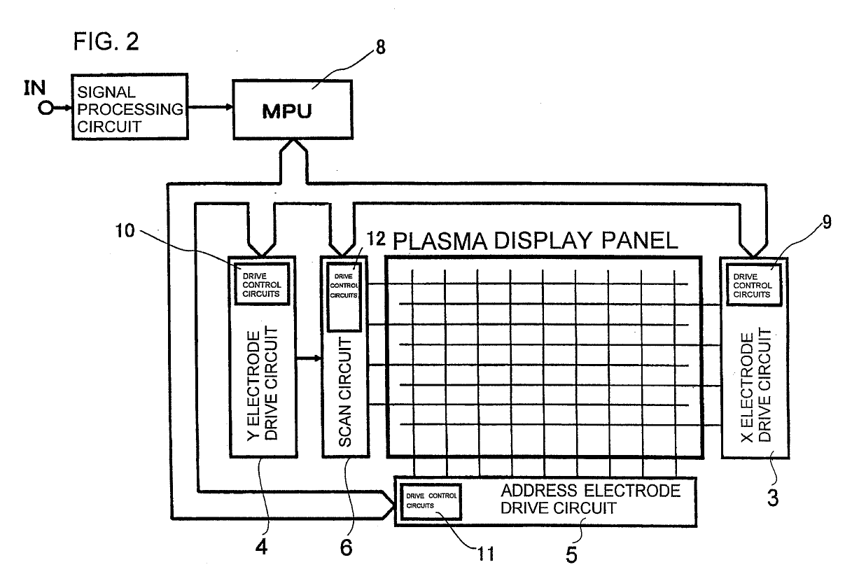

FIG. 2 is a diagram showing a first embodiment of the present invention.

A circuit shown in FIG. 2 includes an X drive control circuit 9 inside an X electrode drive circuit 3 for generating a control signal to be supplied to the X electrode drive circuit; a Y drive control circuit 10 inside a Y electrode drive circuit 4 for generating a control signal to be supplied to the Y electrode drive circuit; an address drive control circuit 11 inside an address electrode drive circuit 5 for generating a control signal to be supplied to the address electrode drive circuit; a scan drive control circuit 12 inside a scan circuit 6 for generating a control signal to be supplied to the scan circuit; and a control device 8 (hereinafter, abbreviated as an ‘MPU’) for supplying trigger signals and DATA signals to the X drive control circuit 9, Y drive control circuit 10, address drive control circuit 11 and scan drive control circuit 12, wherein an X electrode drive pulse, a Y electrode drive pulse, an address electrode drive pulse and scan pulse to be supplied to the X electrode are formed by performing data processing on the trigger signals and DATA signals outputted by the MPU 8.

The trigger signals and DATA signals outputted by the MPU 8 are bus signals which are supplied in common to the X drive control circuit 9, Y drive control circuit 10, address drive control circuit 11 and scan drive control circuit 12. A method of individually supplying the trigger signals and DATA signals to each of the circuits is also thinkable as another embodiment.

The trigger signal outputted from the MPU 8 is formed by encoding information on start time of a reset period, start time of an address period and start time of a sustain period. The DATA signal outputted from the MPU 8 is formed by encoding information such as a phase, pulse width and the number of pulses of the control signals to be supplied to the X electrode drive circuit 3, Y electrode drive circuit 4, address electrode drive circuit 5 and scan circuit 6 from the X drive control circuit 9, Y drive control circuit 10, address drive control circuit 11 and scan drive control circuit 12.

The control signals to be supplied to the X electrode drive circuit 3, Y electrode drive circuit 4, address electrode drive circuit 5 and scan circuit 6 are formed by the X drive control circuit 9, Y drive control circuit 10, address drive control circuit 11 and scan drive control circuit 12 based on the trigger signals and DATA signals outputted by the MPU 8.

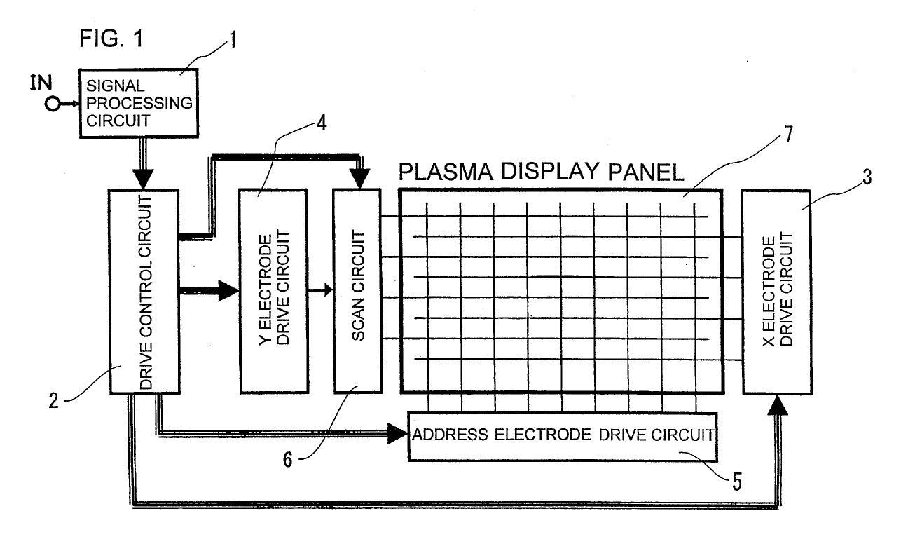

It is possible to reduce circuit size of a drive control circuit 2 in comparison with a conventional example shown in FIG. 1 by using the first embodiment of the present invention shown in FIG. 2. As it suffices to supply the trigger signals and DATA signals outputted by the MPU 8 to the X electrode drive circuit 3, Y electrode drive circuit 4, address electrode drive circuit 5 and scan circuit 6, it is possible to reduce the numbers of cables and pins of connectors for transmitting the control signals which were required in the conventional example (FIG. 1).

Furthermore, it is possible to reduce possibility of a failure due to a malfunction in comparison with the conventional example by providing an error correcting function of the trigger signals and DATA signals outputted by the MPU 8 inside the X drive control circuit 9, Y drive control circuit 10, address drive control circuit 11 and scan drive control circuit 12.

### Second Embodiment

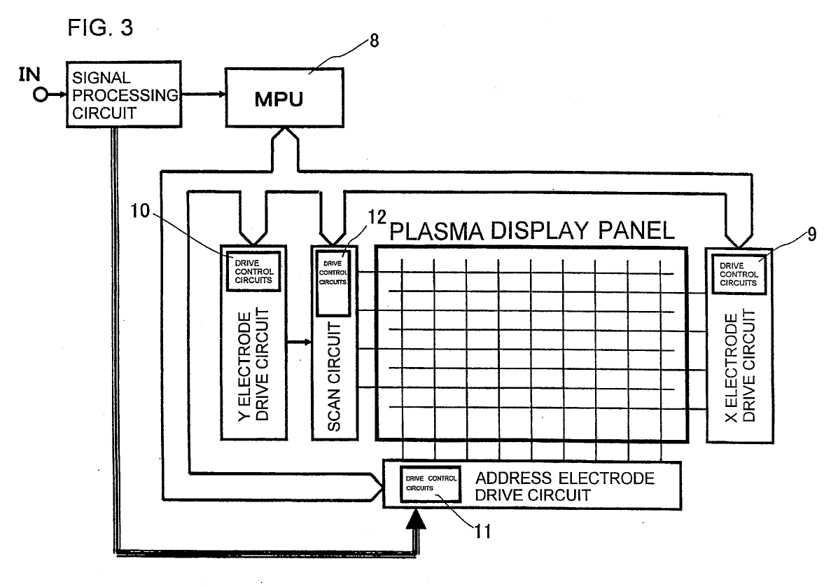

FIG. 3 shows a second embodiment of the present invention. In the embodiment shown in FIG. 3, the address drive control circuit 11 is directly supplied from a signal processing circuit 1 with 10 to 12-bit parallel address electrode drive signals of many pieces of data based on a video signal to be displayed for instance. The address drive control circuit 11 forms the control signal of the address electrode drive circuit 5 from an output signal of the signal processing circuit 1 and the trigger signals and DATA signals outputted by the MPU 8. It is possible, by using the second embodiment, to reduce the number of lines of the bus signals in comparison with the first embodiment.

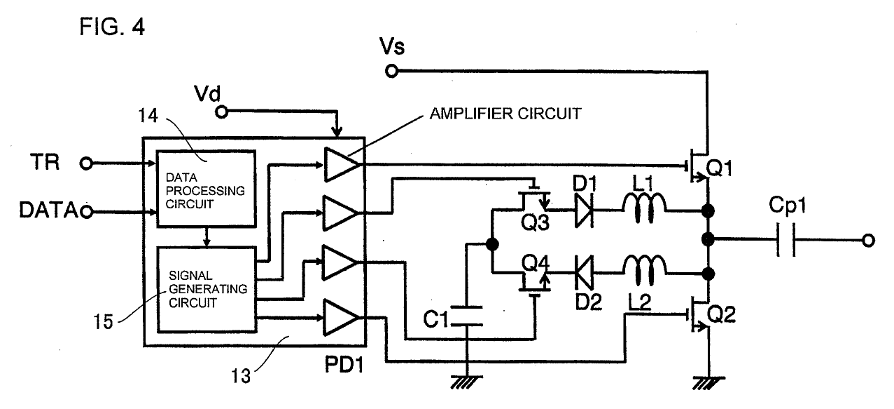

FIG. 4 is a diagram showing a concrete example 1 of a sustain circuit of a plasma display apparatus according to the present invention. In FIG. 4, reference character PD1 denotes a pre-drive circuit 13 for forming a drive pulse to be supplied to sustain output elements Q1 to Q4. The circuit shown in FIG. 4 is characterized by having a data processing circuit 14 and a signal generating circuit 15 provided inside the pre-drive circuit 13. The data processing circuit 14 of FIG. 4 reads the information such as time for generating the drive pulse to be supplied to sustain output elements Q1 to Q4 (start time of a sustain period), phase, pulse width and the number of pulses from the trigger signal (TR) and DATA signal outputted by the MPU of FIG. 2 or 3 and supplies the information to the signal generating circuit 15. The signal generating circuit 15 forms a control signal to be inputted to an amplifier circuit of a subsequent stage based on the output signal of the data processing circuit 14. The amplifier circuit amplifies the control signal and forms the drive pulse to be supplied to Q1 to Q4.

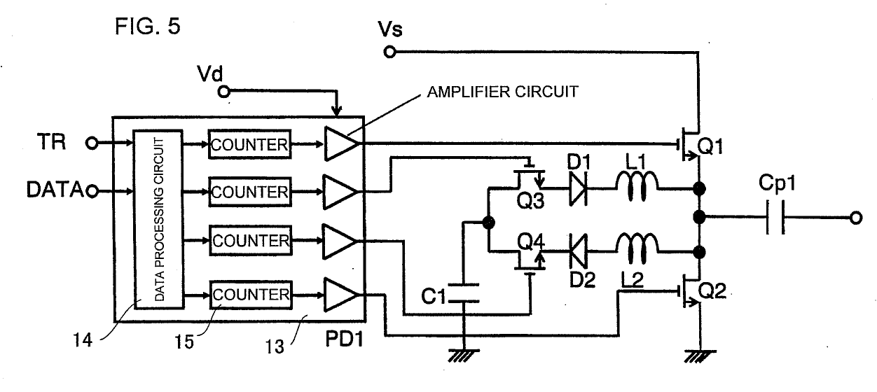

FIG. 5 shows a concrete example 2 of the sustain circuit of the plasma display apparatus according to the present invention. The circuit shown in FIG. 5 uses a counter as the signal generating circuit 15. Information on count start time and count finish time is supplied to the counter from the data processing circuit 14, and each control signal is formed based on this information.

The circuits shown in FIGS. 4 and 5 can normally form the drive pulse to be supplied to Q1 to Q4 even in the case where the trigger signals and DATA signals are disrupted by noise or the like by providing the error correcting function to the data processing circuit 14 in the pre-drive circuit PD1. It is thereby possible to prevent a failure due to a malfunction of the output elements Q1 to Q4 caused by mixing of the noise.

Instead of the trigger signals and DATA signals supplied from the MPU 8, other signals having the same information superposed thereon may also be used. The trigger signals and DATA signals may also be synthesized into one signal and used. Furthermore, a clock signal and other signals may also be supplied together in addition to the trigger signals and DATA signals.

Hereunder, configuration examples of the present invention will be described in additional statements.

Additional statements 1 to 10 are corresponding to claims 1 to 10.

### Additional Statement 1

A plasma display apparatus including:

a plasma display panel;

an X electrode drive circuit for driving an X electrode of the plasma display panel;

a Y electrode drive circuit for driving a Y electrode of the plasma display panel; and

an address electrode drive circuit for driving an address electrode of the plasma display panel, characterized in that:

the apparatus is provided with:

an X drive control circuit inside the X electrode drive circuit for generating a control signal to be supplied to the X electrode drive circuit;

a Y drive control circuit inside the Y electrode drive circuit for generating a control signal to be supplied to the Y electrode drive circuit;

an address drive control circuit inside the address electrode drive circuit for generating a control signal to be supplied to the address electrode drive circuit; and

an MPU for supplying trigger signals and DATA signals to the X drive control circuit, Y drive control circuit and address drive control circuit, characterized in that:

the X drive control circuit, the Y drive control circuit and the address drive control circuit form an X electrode drive pulse, a Y electrode drive pulse and an address electrode drive pulse to be supplied to the X electrode by performing data processing on the trigger signals and DATA signals outputted by the MPU respectively.

### Additional Statement 2

The plasma display apparatus according to the additional statement 1, characterized in that the trigger signals and DATA signals outputted by the MPU are bus signals which are supplied in common to the X drive control circuit, the Y drive control circuit and the address drive control circuit.

### Additional Statement 3

A plasma display apparatus including:

a plasma display panel;

an X electrode drive circuit for driving an X electrode of the plasma display panel;

a Y electrode drive circuit for driving a Y electrode of the plasma display panel;

an address electrode drive circuit for driving an address electrode of the plasma display panel; and

a scan circuit for supplying a scan pulse to the Y electrode, characterized in that:

the apparatus is provided with:

an X drive control circuit inside the X electrode drive circuit for generating a control signal to be supplied to the X electrode drive circuit;

a Y drive control circuit inside the Y electrode drive circuit for generating a control signal to be supplied to the Y electrode drive circuit;

an address drive control circuit inside the address electrode drive circuit for generating a control signal to be supplied to the address electrode drive circuit;

a scan drive control circuit inside the scan circuit for generating a control signal to be supplied to the scan circuit; and

an MPU for supplying trigger signals and DATA signals to the X drive control circuit, Y drive control circuit, address drive control circuit and scan drive control circuit, and

the X drive control circuit, the Y drive control circuit, the address drive control circuit and the scan drive control circuit form an X electrode drive pulse, a Y electrode drive pulse, an address electrode drive pulse and a scan pulse to be supplied to the X electrode by performing data processing on the trigger signals and DATA signals outputted by the MPU respectively.

### Additional Statement 4

The plasma display apparatus according to the additional statement 3, characterized in that the trigger signals and DATA signals outputted by the MPU are bus signals which are supplied in common to the X drive control circuit, the Y drive control circuit, the address drive control circuit and the scan drive control circuit.

### Additional Statement 5

A plasma display apparatus including:

a plasma display panel;

an X electrode drive circuit for driving an X electrode of the plasma display panel;

a Y electrode drive circuit for driving a Y electrode of the plasma display panel;

an address electrode drive circuit for driving an address electrode of the plasma display panel; and

a signal processing circuit for processing an inputted video signal, characterized in that:

the apparatus is provided with:

an X drive control circuit inside the X electrode drive circuit for generating a control signal to be supplied to the X electrode drive circuit;

a Y drive control circuit inside the Y electrode drive circuit for generating a control signal to be supplied to the Y electrode drive circuit;

an address drive control circuit inside the address electrode drive circuit for generating a control signal to be supplied to the address electrode drive circuit; and

an MPU for supplying trigger signals and DATA signals to the X drive control circuit, Y drive control circuit and address drive control circuit, and

an output signal of the signal processing circuit is supplied to the address drive control circuit,

the X drive control circuit and the Y drive control circuit form an X electrode drive pulse and a Y electrode drive pulse to be supplied to the X electrode by performing data processing on the trigger signals and DATA signals outputted by the MPU respectively, and

the address drive control circuit forms an address electrode drive pulse by performing data processing on the trigger signals and DATA signals outputted by the MPU and the output signal of the signal processing circuit.

### Additional Statement 6

The plasma display apparatus according to the additional statement 5, characterized in that the trigger signals and DATA signals outputted by the MPU are bus signals which are supplied in common to the X drive control circuit, the Y drive control circuit and the address drive control circuit.

### Additional Statement 7

A plasma display apparatus including:

a plasma display panel;

an X electrode drive circuit for driving an X electrode of the plasma display panel;

a Y electrode drive circuit for driving a Y electrode of the plasma display panel;

an address electrode drive circuit for driving an address electrode of the plasma display panel;

a scan circuit for supplying a scan pulse to the Y electrode; and

a signal processing circuit for processing an inputted video signal, characterized in that:

the apparatus is provided with:

an X drive control circuit inside the X electrode drive circuit for generating a control signal to be supplied to the X electrode drive circuit;

a Y drive control circuit inside the Y electrode drive circuit for generating a control signal to be supplied to the Y electrode drive circuit;

an address drive control circuit inside the address electrode drive circuit for generating a control signal to be supplied to the address electrode drive circuit; and

a scan drive control circuit inside the scan circuit for generating a control signal to be supplied to the scan circuit; and

an MPU for supplying trigger signals and DATA signals to the X drive control circuit, Y drive control circuit, address drive control circuit and scan drive control circuit, and

an output signal of the signal processing circuit is supplied to the address drive control circuit,

the X drive control circuit, the Y drive control circuit and the scan drive control circuit form an X electrode drive pulse, a Y electrode drive pulse and scan pulse to be supplied to the X electrode by performing data processing on the trigger signals and DATA signals outputted by the MPU respectively, and

the address drive control circuit forms an address electrode drive pulse by performing data processing on the trigger signals and DATA signals outputted by the MPU and the output signal of the signal processing circuit.

### Additional Statement 8

The plasma display apparatus according to the additional statement 7, characterized in that the trigger signals and DATA signals outputted by the MPU are bus signals which are supplied in common to the X drive control circuit, the Y drive control circuit, the address drive control circuit and the scan drive control circuit.

### Additional Statement 9

A plasma display apparatus including:

a plasma display panel; and

a Y electrode drive circuit for driving an X electrode of the plasma display panel, characterized in that:

the apparatus is provided with:

an X drive control circuit inside the X electrode drive circuit for generating a control signal to be supplied to the X electrode drive circuit;

a Y drive control circuit inside the Y electrode drive circuit for generating a control signal to be supplied to the Y electrode drive circuit; and

an MPU for supplying information necessary for pulse formation to the X drive control circuit and Y drive control circuit, and

the X drive control circuit and the Y drive control circuit form an X electrode drive pulse and a Y electrode drive pulse to be supplied to the X electrode by performing data processing on output information of the MPU respectively.

### Additional Statement 10

The plasma display apparatus according to the additional statement 9, characterized in that the information necessary for pulse formation outputted by the MPU is a bus signal which is supplied in common to the X drive control circuit and the Y drive control circuit.

### Additional Statement 11

The plasma display apparatus according to the additional statement 1, characterized in that:

clock signals and DATA signals are used instead of the trigger signals and DATA signals; and

information such as a phase of a pulse and pulse width outputted from the X drive control circuit, Y drive control circuit, address drive control circuit and the like is encoded and superimposed on the DATA signal.

### Additional Statement 12

The plasma display apparatus according to the additional statement 1, characterized in that, instead of the MPU, a logic circuit having an equivalent function is used.

### Additional Statement 13

The plasma display apparatus according to the additional statement 2, characterized in that the bus signals are configured by using clock signals and DATA signals.

### Additional Statement 14

The plasma display apparatus according to the additional statement 13, characterized in that the bus signals are configured by using a I2C bus.

### Additional Statement 15

The plasma display apparatus according to the additional statement 1, characterized in that the X drive control circuit and Y drive control circuit are formed inside a pre-drive circuit for forming a drive pulse to be supplied to output elements of a sustain circuit of the plasma display apparatus.

### Additional Statement 16

The plasma display apparatus according to the additional statement 15, characterized in that the pre-drive circuit is configured by using:

a data processing circuit for reading information such as a phase and pulse width of a drive pulse supplied to output elements of a sustain circuit from the trigger signals and DATA signals (or clock signals and DATA signals) outputted from the MPU (or a logic circuit having an equivalent function);

a signal generating circuit for generating a control signal based on an output signal from the data processing circuit; and

an amplifier circuit for amplifying the output signal of the signal generating circuit.

### Additional Statement 17

The plasma display apparatus according to the additional statement 16, characterized in that the signal generating circuit is configured by using a counter.

### Additional Statement 18

The plasma display apparatus according to the additional statement 17, characterized in that the counter starts or stops countup or countdown based on the information such as a phase and pulse width of a drive pulse outputted from the data processing circuit.

### Additional Statement 19

The plasma display apparatus according to the additional statement 3, characterized by having an error correcting function of correcting an error of a signal from the MPU (or a logic circuit having an equivalent function) to be inputted to one of the X drive control circuit, Y drive control circuit, address drive control circuit and scan drive control circuit.

### Additional Statement 20

The plasma display apparatus according to the additional statement 3, characterized in that, in the absence of part or all of signals from the MPU (or a logic circuit having an equivalent function) to be inputted to one of the X drive control circuit, Y drive control circuit, address drive control circuit and scan drive control circuit, a part (or all) of signals outputted from the X drive control circuit, Y drive control circuit, address drive control circuit and scan drive control circuit is set in a nonactive state (state of turning off output elements and the like).

### Additional Statement 21

The plasma display apparatus according to the additional statement 3, characterized in that, in the absence of a part of signals from the MPU (or a logic circuit having an equivalent function) to be inputted to the X drive control circuit, Y drive control circuit, address drive control circuit and scan drive control circuit or in the case of being unable to normally read it due to noise or the like being superimposed, part (or all) of signals outputted from the X drive control circuit, Y drive control circuit, address drive control circuit and scan drive control circuit is set in a nonactive state (state of turning off output elements and the like).

1. A plasma display apparatus comprising:
a plasma display panel;
an X electrode drive circuit for driving an X electrode of the plasma display panel;
a Y electrode drive circuit for driving a Y electrode of the plasma display panel; and
an address electrode drive circuit for driving an address electrode of the plasma display panel,
characterized in that:
the apparatus is provided with:
an X drive control circuit inside the X electrode drive circuit for generating a control signal to be supplied to the X electrode drive circuit;
a Y drive control circuit inside the Y electrode drive circuit for generating a control signal to be supplied to the Y electrode drive circuit;
an address drive control circuit inside the address electrode drive circuit for generating a control signal to be supplied to the address electrode drive circuit; and
an MPU for supplying trigger signals and DATA signals to the X drive control circuit, Y drive control circuit and address drive control circuit, characterized in that:
the X drive control circuit, the Y drive control circuit and the address drive control circuit form an X electrode drive pulse, a Y electrode drive pulse and an address electrode drive pulse to be supplied to the X electrode by performing data processing on the trigger signals and DATA signals outputted by the MPU respectively.

2. The plasma display apparatus according to claim 1, characterized in that the trigger signals and DATA signals outputted by the MPU are bus signals which are supplied in common to the X drive control circuit, the Y drive control circuit and the address drive control circuit.

3. A plasma display apparatus including:
a plasma display panel;
an X electrode drive circuit for driving an X electrode of the plasma display panel;
a Y electrode drive circuit for driving a Y electrode of the plasma display panel;
an address electrode drive circuit for driving an address electrode of the plasma display panel; and
a scan circuit for supplying a scan pulse to the Y electrode, characterized in that:
the apparatus is provided with:
an X drive control circuit inside the X electrode drive circuit for generating a control signal to be supplied to the X electrode drive circuit;
a Y drive control circuit inside the Y electrode drive circuit for generating a control signal to be supplied to the Y electrode drive circuit;
an address drive control circuit inside the address electrode drive circuit for generating a control signal to be supplied to the address electrode drive circuit;
a scan drive control circuit inside the scan circuit for generating a control signal to be supplied to the scan circuit; and
an MPU for supplying trigger signals and DATA signals to the X drive control circuit, Y drive control circuit, address drive control circuit and scan drive control circuit, and
the X drive control circuit, the Y drive control circuit, the address drive control circuit and the scan drive control circuit form an X electrode drive pulse, a Y electrode drive pulse, an address electrode drive pulse and a scan pulse to be supplied to the X electrode by performing data processing on the trigger signals and DATA signals outputted by the MPU respectively.

4. The plasma display apparatus according to claim 3, characterized in that the trigger signals and DATA signals outputted by the MPU are bus signals which are supplied in common to the X drive control circuit, the Y drive control circuit, the address drive control circuit and the scan drive control circuit.

5. A plasma display apparatus including:
a plasma display panel;
an X electrode drive circuit for driving an X electrode of the plasma display panel;
a Y electrode drive circuit for driving a Y electrode of the plasma display panel;
an address electrode drive circuit for driving an address electrode of the plasma display panel; and
a signal processing circuit for processing an inputted video signal, characterized in that:
the apparatus is provided with:
an X drive control circuit inside the X electrode drive circuit for generating a control signal to be supplied to the X electrode drive circuit;
a Y drive control circuit inside the Y electrode drive circuit for generating a control signal to be supplied to the Y electrode drive circuit;
an address drive control circuit inside the address electrode drive circuit for generating a control signal to be supplied to the address electrode drive circuit; and
an MPU for supplying trigger signals and DATA signals to the X drive control circuit, Y drive control circuit and address drive control circuit, and
an output signal of the signal processing circuit is supplied to the address drive control circuit,
the X drive control circuit and the Y drive control circuit form an X electrode drive pulse and a Y electrode drive pulse to be supplied to the X electrode by performing data processing on the trigger signals and DATA signals outputted by the MPU respectively, and
the address drive control circuit forms an address electrode drive pulse by performing data processing on the trigger signals and DATA signals outputted by the MPU and the output signal of the signal processing circuit.

6. The plasma display apparatus according to claim 5, characterized in that the trigger signals and DATA signals outputted by the MPU are bus signals which are supplied in common to the X drive control circuit, the Y drive control circuit and the address drive control circuit.

7. A plasma display apparatus including:
a plasma display panel;
an X electrode drive circuit for driving an X electrode of the plasma display panel;
a Y electrode drive circuit for driving a Y electrode of the plasma display panel;
an address electrode drive circuit for driving an address electrode of the plasma display panel;
a scan circuit for supplying a scan pulse to the Y electrode; and
a signal processing circuit for processing an inputted video signal, characterized in that:
the apparatus is provided with:
an X drive control circuit inside the X electrode drive circuit for generating a control signal to be supplied to the X electrode drive circuit;
a Y drive control circuit inside the Y electrode drive circuit for generating a control signal to be supplied to the Y electrode drive circuit;
an address drive control circuit inside the address electrode drive circuit for generating a control signal to be supplied to the address electrode drive circuit; and
a scan drive control circuit inside the scan circuit for generating a control signal to be supplied to the scan circuit; and
an MPU for supplying trigger signals and DATA signals to the X drive control circuit, Y drive control circuit, address drive control circuit and scan drive control circuit, and
an output signal of the signal processing circuit is supplied to the address drive control circuit,
the X drive control circuit, the Y drive control circuit and the scan drive control circuit form an X electrode drive pulse, a Y electrode drive pulse and a scan pulse to be supplied to the X electrode by performing data processing on the trigger signals and DATA signals outputted by the MPU respectively, and
the address drive control circuit forms an address electrode drive pulse by performing data processing on the trigger signals and DATA signals outputted by the MPU and the output signal of the signal processing circuit.

8. The plasma display apparatus according to claim 7, characterized in that the trigger signals and DATA signals outputted by the MPU are bus signals which are supplied in common to the X drive control circuit, the Y drive control circuit, the address drive control circuit and the scan drive control circuit.

9. A plasma display apparatus including:
a plasma display panel; and
a Y electrode drive circuit for driving an X electrode of the plasma display panel, characterized in that:
the apparatus is provided with:
an X drive control circuit inside the X electrode drive circuit for generating a control signal to be supplied to the X electrode drive circuit;
a Y drive control circuit inside the Y electrode drive circuit for generating a control signal to be supplied to the Y electrode drive circuit; and
an MPU for supplying information necessary for pulse formation to the X drive control circuit and Y drive control circuit, and
the X drive control circuit and the Y drive control circuit form an X electrode drive pulse and a Y electrode drive pulse to be supplied to the X electrode by performing data processing on output information of the MPU respectively.

10. The plasma display apparatus according to claim 9, characterized in that the information necessary for pulse formation outputted by the MPU is a bus signal which is supplied in common to the X drive control circuit and the Y drive control circuit.
